(19) United States
(12) Patent Application Publication
(10) Pub. No.: US 2026/0274128 A1
(43) Pub. Date: Sep. 17, 2026

(54) STOWABLE VEHICLE SEAT ASSEMBLY AND VEHICLE WITH OPEN MIDGATE CONFIGURATION

(71) Applicant: NISSAN NORTH AMERICA, INC., Franklin, TN (US)

(72) Inventors: Andre OLIVEIRA FERNANDES, Walled Lake, MI (US); Tracy SPAGNUOLO, Brighton, MI (US); Devon Michael VOGT, Brighton, MI (US); Mitsuyasu HIKOSAKA, Novi, MI (US); Justin SAMMONS, Riverview, MI (US)

(21) Appl. No.: 19/076,646

(22) Filed: Mar. 11, 2025

(51) Int. Cl. B60N 2/36; B60N 2/16; B60N 2/30; B60N 2/859; B60N 2/75

(52) U.S. Cl. CPC B60N 2/36; B60N 2/1615; B60N 2/3011; B60N 2/859; B60N 2002/363; B60N 2/757

(57) ABSTRACT

Vehicles and adjustable seat assemblies are disclosed herein. In an embodiment, a vehicle seat assembly includes a seat bottom, a seat backrest and a plurality of support linkages. The seat backrest is pivotally attached to the seat bottom. The support linkages are configured to support the seat bottom above a vehicle floor. The support linkages each have a first end and a second end. The first end is configured to pivotally attach to the vehicle floor, and the second end is pivotally attached to the seat bottom. The support linkages are configured to simultaneously pivot at the first and second ends to move the seat bottom towards the vehicle floor when the seat bottom moves from an upright configuration to a stowed configuration and to move the seat bottom away from the vehicle floor when the seat bottom moves from the stowed configuration to the upright configuration.

### BACKGROUND

### Technical Field

The present disclosure generally relates to a stowable seat assembly for a vehicle. The present disclosure also generally relates to a vehicle having a seat assembly that enables an open midgate configuration.

### Background Information

Pickup trucks are known for their usefulness in moving cargo such as lumber, furniture, and other large commercial and personal items. To make room for a cargo bed, pickup trucks typically have small passenger cabins with limited space. The limited space in the passenger cabin does not leave much room for movement of the vehicle seats and/or the midgate separating the passenger cabin from the cargo area.

### SUMMARY

The present disclosure provides a versatile vehicle seat that maximizes space in the passenger cabin of a pickup truck. The vehicle seat and the mechanisms described herein can also be advantageously applied other types of vehicles besides pickup trucks to maximize space and versatility.

In view of the state of the known technology, one aspect of the present disclosure is to provide a vehicle seat assembly. The vehicle seat assembly includes a seat bottom, a seat backrest and a plurality of support linkages. The seat backrest is pivotally attached to the seat bottom. The plurality of support linkages are configured to support the seat bottom above a vehicle floor. The plurality of support linkages each have a first end and a second end. The first end is configured to pivotally attach to the vehicle floor and the second end is pivotally attached to the seat bottom. The plurality of support linkages are configured to simultaneously pivot at both the first end and the second end to move the seat bottom towards the vehicle floor when the seat bottom moves from an upright configuration to a stowed configuration and to move the seat bottom away from the vehicle floor when the seat bottom moves from the stowed configuration to the upright configuration.

A second aspect of the present disclosure is to provide a vehicle. The vehicle includes a passenger cabin, a cargo area, a vehicle seat, a pivot structure and a midgate. The passenger cabin has a front side, a rear side and a floor. The cargo area is located on the rear side of the passenger cabin. The vehicle seat is located inside the passenger cabin. The vehicle seat includes a seat bottom and a seat backrest and is configured to move between an upright configuration and a stowed configuration. The pivot structure attaches the seat bottom to the floor of the passenger cabin and is configured to (i) pivot the seat bottom towards the floor when the vehicle seat moves from the upright configuration to the stowed configuration and (ii) pivot the seat bottom away from the floor when the vehicle seat moves from the stowed configuration to the upright configuration. The midgate is located between the passenger cabin and the cargo area. The midgate is configured to move between (i) an open configuration in which the passenger cabin is open to the cargo area, the vehicle seat is in the stowed configuration, and the midgate is located above the seat bottom and the seat backrest and (ii) a closed configuration in which the passenger cabin is closed off from the cargo area by the midgate and the vehicle seat is in the upright configuration.

A third aspect of the present disclosure is to provide another vehicle. The vehicle includes a passenger cabin, a cargo area, a vehicle seat and a midgate. The passenger cabin has a front side and a rear side. The cargo area is located on the rear side of the passenger cabin. The vehicle seat is located inside the passenger cabin. The vehicle seat includes a seat bottom and a seat backrest and is configured to move between an upright configuration and a stowed configuration. The midgate is located between the passenger cabin and the cargo area. The midgate is configured to move between (i) an open configuration in which the passenger cabin is open to the cargo area, the vehicle seat is in the stowed configuration, and an upper surface of the midgate is generally horizontal and located above the seat bottom and the seat backrest and (ii) a closed configuration in which the passenger cabin is closed off from the cargo area by the midgate and the vehicle seat is in the upright configuration.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 is a rear perspective view of an example embodiment of a vehicle including a vehicle seat and a midgate configured in accordance with the present disclosure;

FIG. 2 is a side elevational view of the vehicle of FIG. 1;

FIG. 3 is a side elevational view into the vehicle at Section A of FIG. 2 which shows the vehicle seat assembly in the upright configuration and the midgate in the closed configuration;

FIG. 4 is another side elevational view into the vehicle at Section A of FIG. 2 which shows the midgate in the closed configuration;

FIG. 5 is another side elevational view into the vehicle at Section A of FIG. 2 which shows the vehicle seat assembly in the stowed configuration and the midgate in the closed configuration;

FIG. 6 is another side elevational view into the vehicle at Section A of FIG. 2 which shows the vehicle seat assembly in the stowed configuration and the midgate in the open configuration;

FIG. 7 is a front perspective view of the vehicle seat assembly in the upright configuration;

FIG. 8 is a rear perspective view of the vehicle seat assembly in the upright configuration;

FIG. 9 is another front perspective view of the vehicle seat assembly;

FIG. 10 is another front perspective view of the vehicle seat assembly;

FIG. 11 is another front perspective view of the vehicle seat assembly;

FIG. 12 is another front perspective view of the vehicle seat assembly;

FIG. 13 is a side plan view showing movement of the vehicle seat assembly between the upright configuration and the stowed configuration;

FIG. 14 is a front perspective view of the vehicle seat assembly in the stowed configuration and the midgate in the closed configuration;

FIG. 15 is a rear perspective view of the vehicle seat assembly in the stowed configuration and the midgate in the closed configuration;

FIG. 16 is a front perspective view of the vehicle seat assembly in the stowed configuration and the midgate in the open configuration;

FIG. 17 is a rear perspective view of the vehicle seat assembly in the stowed configuration and the midgate in the open configuration;

FIG. 18 is a front perspective detailed view of the pivot structure of the vehicle seat assembly; and

FIG. 19 is a front perspective detailed view of certain parts of the pivot structure of the vehicle seat assembly.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

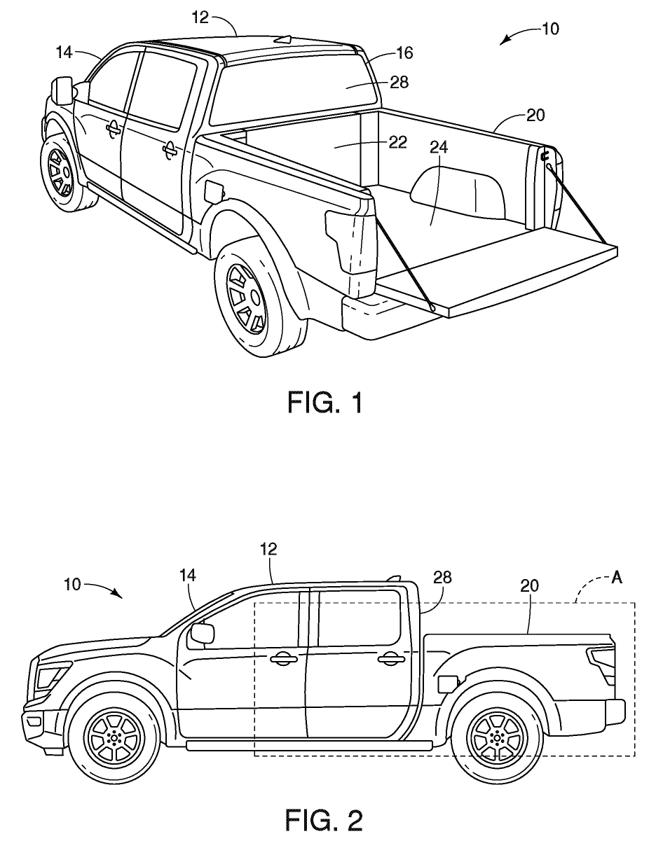

FIGS. 1 to 6 illustrate an example embodiment of a vehicle 10 in accordance with the present disclosure. The vehicle 10 generally includes a passenger cabin 12 having a front side 14, a rear side 16 and a floor 18. The vehicle 10 also generally includes a cargo area 20 located on the rear side 16 of the passenger cabin 12, a midgate 22 located between the passenger cabin 12 and the cargo area 20, and a vehicle seat assembly (or “vehicle seat”) 100 located inside the passenger cabin 12 and attached to the vehicle floor 18. The illustrated cargo area 20 is open to the outside environment, but the cargo area 20 can also be closed off from the outside environment. The illustrated vehicle seat 100 is the back row of a pickup truck having an extended passenger cabin 12, but the vehicle seat 100 and its assemblies and mechanisms disclosed herein can be applied to the vehicle seats in any pickup truck, as well as to vehicle seats in other types of vehicles 10.

The midgate 22 is configured to move between a closed configuration and an open configuration. More specifically, the midgate 22 is pivotally attached to the rest of the wall separating the passenger cabin 12 and the cargo area 20, and the midgate 22 pivots into the passenger cabin 12 when moving from the closed configuration to the open configuration. In an embodiment, the midgate 20 can also pivot away from the passenger cabin 12 and into the cargo area 20.

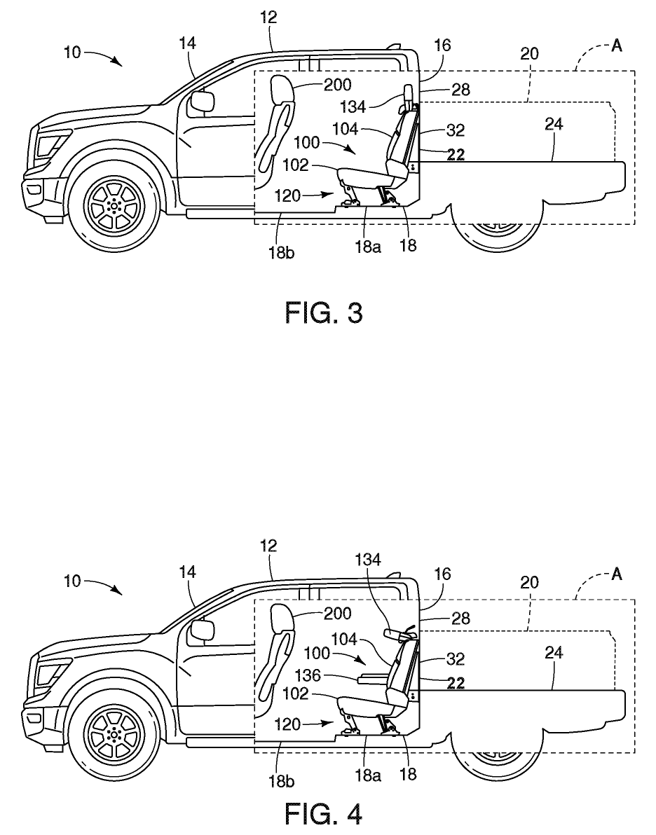

FIGS. 3 to 5 show the midgate 22 in the closed configuration, while FIG. 6 shows the midgate 22 in the open configuration. In the closed configuration shown in FIGS. 3 to 5, the midgate 22 closes off the passenger cabin 12 from the cargo area 20. In the open configuration shown in FIG. 6, the passenger cabin 12 is open to the cargo area 20. That is, in the open configuration, the midgate 22 creates an open space 26 between the passenger cabin 12 and the cargo area 20 which exposes the passenger cabin 12 to the cargo area 20. The rear side 16 of the passenger cabin 12 can further include a moveable or removeable rear window or other panel 28 to increase the height of the open space 26 when the midgate 22 is in the open configuration. The open configuration can be used to increase space in the cargo area 20 for cargo such as lumber or other large items that are longer than the length of the cargo area floor 24. The open configuration also enables a passenger to sit on the midgate 22 facing the cargo area 20.

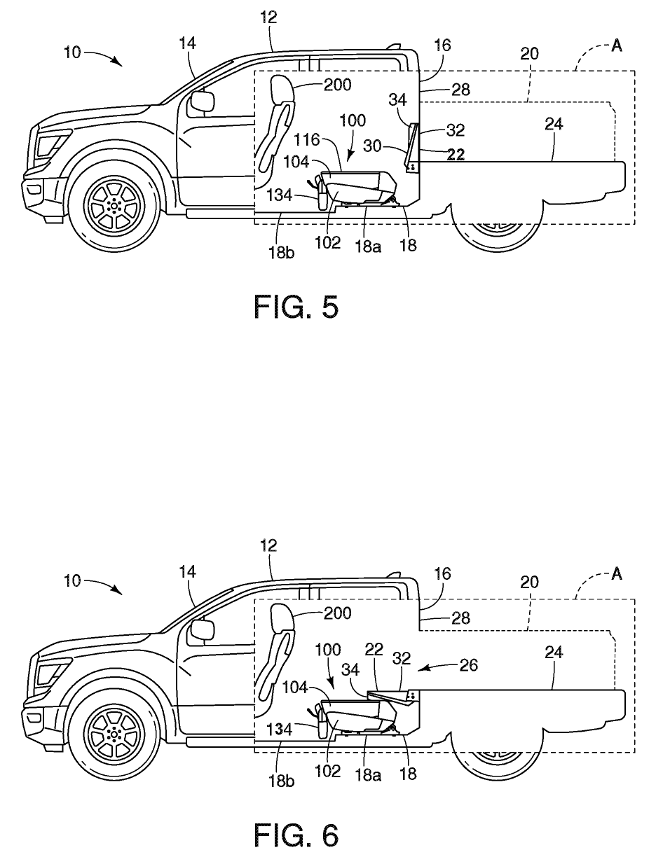

In the illustrated embodiment, the midgate 22 includes a first surface 30 and a second surface 32. The second surface 32 is on the opposite side of the midgate 22 than the first surface 30. As seen in FIG. 5, the second surface 32 is a generally vertical side surface for the cargo area 20 when the midgate 22 is in the closed configuration. In this configuration, the front surface 30 forms at least a portion of an inner wall of the passenger cabin 12, while the rear surface 32 forms at least a portion of the side wall of the cargo area 20. As seen in FIG. 6, the second surface 32 is a generally horizontal upper surface located above the vehicle seat 100 when the midgate 22 is in the open configuration. The generally horizontal second surface 32 is also approximately level with the cargo area floor 24 in the vertical direction when the midgate 22 is in the open configuration. The second surface 32 being approximately level with the cargo area floor 24 is enabled by the collapsable vehicle seat 100 disclosed herein.

In the illustrated embodiment, the midgate 22 also includes a protruding surface 34 which protrudes outwardly from the front surface 30. The protruding surface 34 can be, for example, a cushioned or slightly deformable surface that is attached to the front surface 30. As seen in FIG. 6, the protruding surface 34 rests on the vehicle seat 100 and supports the midgate 22 in the open configuration so that additional weight can be placed on top of the midgate 22.

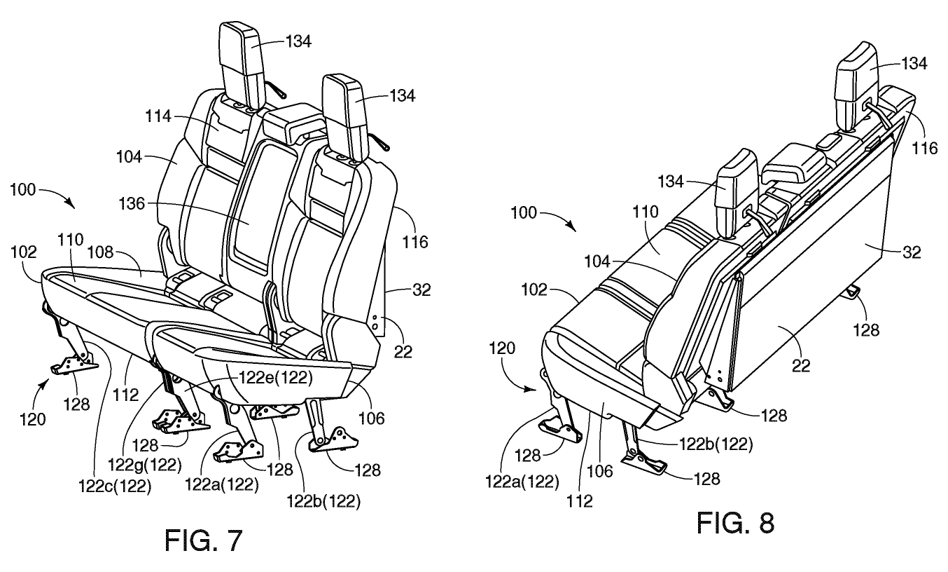

FIGS. 7 to 17 illustrate the vehicle seat 100 in more detail. In the illustrated embodiment, the vehicle seat 100 generally includes a seat bottom 102 and a seat backrest 104. The seat backrest 104 extends upward from the seat bottom 102. The seat backrest 104 is also pivotally attached to the seat bottom 102. The seat bottom 102 and the seat backrest 104 generally extend laterally from a first lateral side 106 of the vehicle seat 100 to a second lateral side 108 of the vehicle seat 100 to form a bench seat for multiple passengers. As used herein, the lateral direction generally refers to the sideways direction of the vehicle 10 and vehicle seat 100.

The seat bottom 102 generally includes an upper surface 110 and a lower surface 112. The upper surface 110 and the lower surface 112 generally extend laterally from the first lateral side 106 of the vehicle seat 100 to the second lateral side 108 of the vehicle seat 100. The upper surface 110 includes cushioning and supports one or more seated passengers. The bottom surface 112 connects to a pivot structure 120 which enables the seat bottom 102 to translate towards and away from the floor 18 of the passenger cabin 12, as discussed in more detail below. In an embodiment, parts of the pivot structure 120 are integrally formed with the seat bottom 102.

The seat backrest 104 generally includes a front surface 114 and a rear surface 116. The front surface 114 includes cushioning and acts as a backrest for one or more passengers when the vehicle seat 100 is in an upright configuration. The rear surface 116 is opposite the front surface 114 and supports the midgate 22 above the vehicle seat 100 when the vehicle seat 100 is in a stowed configuration and the midgate 22 is in the open configuration.

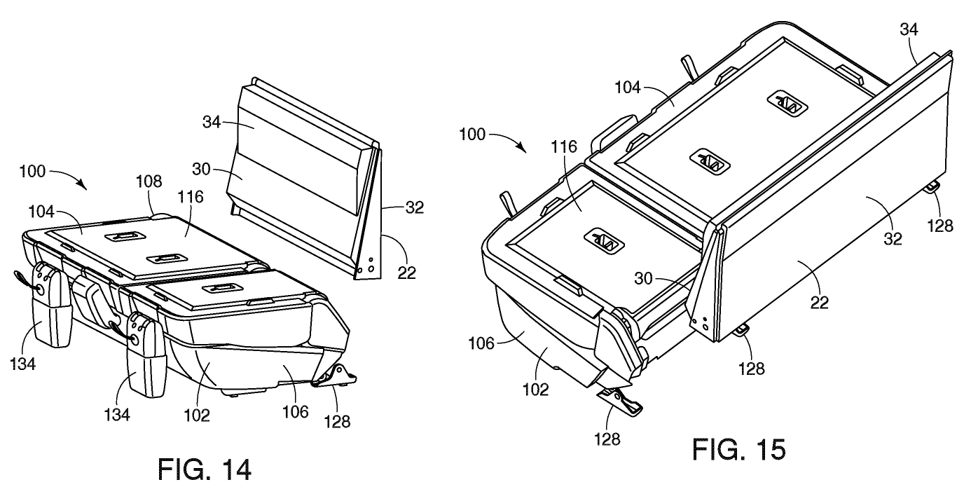

In the illustrated embodiment, the vehicle seat 100 is configured to move between the upright configuration and the stowed configuration. More specifically, both the seat bottom 102 and the seat backrest 104 are configured to move between the upright configuration and the stowed configuration. FIGS. 7 and 8 show the seat bottom 102 and the seat backrest 104 both in their respective upright configuration, while FIGS. 14 and 15 show the seat bottom 102 and the seat backrest 104 both in their respective stowed configuration. The seat bottom 102 pivots forward towards the vehicle floor 18 to move from the upright configuration to the stowed configuration, and pivots upward away from the vehicle floor 18 to move from the stowed configuration back to the upright configuration. The seat backrest 104 pivots forward towards the seat bottom 102 to move from the upright configuration to the stowed configuration, and pivots upward away from the seat bottom 102 to move from the stowed configuration back to the upright configuration.

The movement of the vehicle seat 100 between the upright configuration and the stowed configuration enables the midgate 22 to move between the closed configuration and the open configuration. When the vehicle seat 100 is located in the upright configuration, the vehicle seat 100 blocks the midgate 22 from moving from the closed configuration to the open configuration. When the vehicle seat 100 is located in the stowed configuration, the midgate 22 can move freely between the closed configuration and the open configuration. When the midgate 22 is in the open configuration, the passenger cabin 12 is open to the cargo area 20, the seat bottom 102 is in the stowed configuration, and the midgate 22 is located above the seat bottom 102 and the seat backrest 104 (e.g., as seen in FIG. 6). When the midgate 22 is in the closed configuration, the passenger cabin 12 is closed off from the cargo area 20 by the midgate 22 and the seat bottom 102 can be placed in the upright configuration (e.g., as seen in FIG. 3).

In the illustrated embodiment, the vehicle seat 100 includes a pivot structure 120. The pivot structure 120 attaches the seat bottom 102 to the floor 18 of the passenger cabin 12. The pivot structure 120 is configured to pivot the seat bottom 102 towards the floor 18 when the vehicle seat 100 moves from the upright configuration to the stowed configuration, and to pivot the seat bottom 102 away from the floor 18 when the vehicle seat 100 moves from the stowed configuration to the upright configuration. As seen in FIGS. 5 and 6, the pivot structure 120 is generally configured to collapse the seat bottom 102 into the stowed configuration. When the seat bottom 102 is in the upright configuration, there is an open space below the seat bottom 102. When the pivot structure 120 collapses the seat bottom 102 into the stowed configuration, the seat bottom 102 moves into the open space, and the seat backrest 104 moves into the space previously occupied by the seat bottom 102.

In the illustrated embodiment, the pivot structure 120 includes a plurality of support linkages 122 that support the seat bottom 102 above the floor 18 of the passenger cabin 12. The plurality of support linkages 122 attach the seat bottom 102 to the floor 18. In an embodiment, the plurality of support linkages 122 are the only elements supporting the seat bottom 102 above the vehicle floor 18 and support the entire weight of the vehicle seat 100 when the vehicle seat 100 is in the upright configuration.

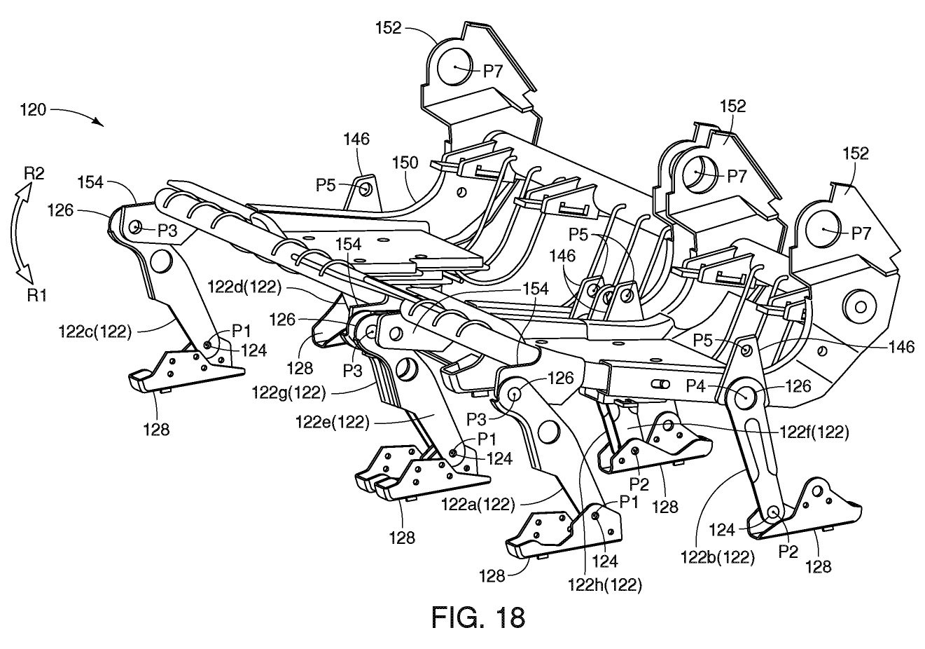

FIG. 18 illustrates the plurality of support linkages 122 in more detail. As seen in FIG. 18, each of the support linkages 122 has a first end 124 and a second end 126. The first end 124 is pivotally attached to the floor 18 of the passenger cabin 12. More specifically, the first ends 124 are pivotally attached to the vehicle floor 18 via brackets 128 fixed to the vehicle floor 18. That is, the pivot structure 120 includes a plurality of brackets 128 fixed to the floor 18, and the first ends 124 of the support linkages 122 are each pivotally attached to a respective bracket 128. The second end 126 of each support linkage 122 is pivotally attached to the seat bottom 104. More specifically, the second ends 126 are pivotally attached at or near the lower surface 112 of the frame 150 of the seat bottom 104. As seen in FIG. 18, the support linkages 122 include apertures at both the first end 124 and the second end 126. The first ends 124 and the second ends 126 are attached to the brackets 128 and the frame 150, respectively, by placing a connector or axle through the apertures to enable the first ends 124 and the second ends 126 to rotate around the central axes of the apertures at a respective pivot point P1, P2, P3 or P4.

The plurality of support linkages 122 are configured to simultaneously pivot at both the first end 124 and the second end 126 to move the seat bottom 102 towards the vehicle floor 18 when the seat bottom 102 moves from the upright configuration to the stowed configuration. When moving from the upright configuration to the stowed configuration, the support linkages 122 pivot around the first ends 124 at pivot points P1 or P2 in the rotational direction R1 shown in FIG. 22, and the support linkages 122 pivot around the second ends 126 at pivot points P3 or P4 in the same rotational direction R1. The plurality of support linkages 122 are also configured to simultaneously pivot at both the first end 124 and the second end 126 to move the seat bottom 102 away from the vehicle floor 18 when the seat bottom 102 moves from the stowed configuration to the upright configuration. When moving from the stowed configuration to the upright configuration, the support linkages 122 pivot around the first ends 124 at pivot points P1 or P2 in the rotational direction R2 shown in FIG. 22, and the support linkages 122 pivot around the second ends 126 at pivot points P3 or P4 in the same rotational direction R2.

In the illustrated embodiment, the plurality of support linkages 122 include at least a first support linkage 122 located on the first lateral side 106 of the seat bottom 102 and a second support linkage 122 located on the opposite second lateral side 108 of the seat bottom 102. More specifically, the plurality of linkages 122 include a first support linkage 122a, a second support linkage 122b, a third support linkage 122c, a fourth support linkage 122d, a fifth support linkage 122e, a sixth support linkage 122f, a seventh support linkage 122g and an eighth support linkage 122h. The first support linkage 122a and the second support linkage 122b are located on the first lateral side 106 of the vehicle seat 100. The third support linkage 122c and the fourth support linkage 122d are located on the second lateral side 108 of the vehicle seat 100. The fifth support linkage 122e, the sixth support linkage 122f, the seventh support linkage 122g and the eighth support linkage 122h are located beneath the seat bottom 102 at intermediate locations between the first lateral side 106 and the second lateral side 108. In the illustrated embodiment, the fifth support linkage 122e, the sixth support linkage 122f, the seventh support linkage 122g and the eighth support linkage 122h are located closer to the first lateral side 106 than to the second lateral side 108 (e.g., with approximately 60% of the lateral length of the vehicle seat 100 to the second lateral side 108 and approximately 40% of the lateral length of the vehicle seat 100 to the first lateral side 106). The first support linkage 122a, the support third linkage 122c, the fifth support linkage 122e and the seventh support linkage 122g (i.e., the support linkages at the front of the vehicle seat 100) all have the same shape. Likewise, the second support linkage 122b, the fourth support linkage 122d, the sixth support linkage 122f and the eighth support linkage 122h (i.e., the linkages at the rear of the vehicle seat 100) all have the same shape. Those of ordinary skill of the art will recognize from this disclosure that more or less support linkages 122 can be used.

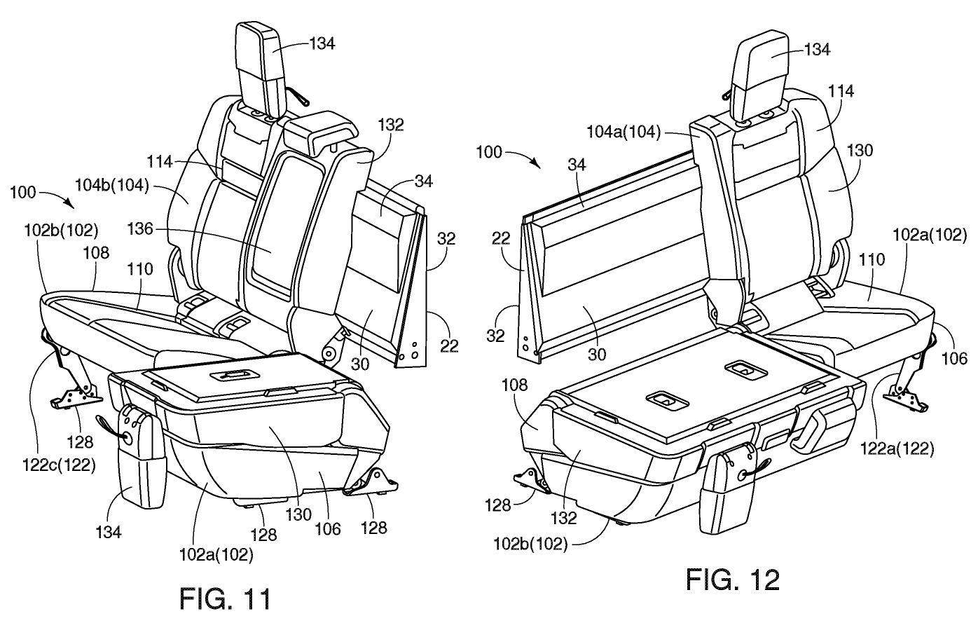

As seen in FIGS. 11 and 12, the illustrated vehicle seat 100 includes a first part 130 and a second part 132 configured to pivot into the stowed position independently of each other. The first part 130 includes a seat bottom first part 102a and a seat backrest first part 104a, and the second part 132 includes a seat bottom second part 102b and a seat backrest second part 104b. FIG. 11 shows the first part 130 including the seat bottom first part 102a and the seat backrest first part 104a pivoting into the stowed configuration while the second part 132 remains in the upright configuration against the midgate 22. FIG. 12 shows the second part 132 including the seat bottom second part 102b and the seat backrest second part 104b pivoting into the stowed configuration while the first part 130 remains in the upright configuration against the midgate 22. In the illustrated embodiment, the first part 130 is approximately 40% of the lateral length of the vehicle seat 100, and the second part 132 is approximately 60% of the lateral length of the vehicle seat 100.

FIGS. 11 and 12 also show how the support linkages 122 support the first part 130 and the second part 132. Four of the support linkages 122 support the first part 130 and move the first part 130 into the stowed and upright configurations, and four of the support linkages 122 support the second part 132 and move the second part 132 into the stowed and upright configurations. That is, the first support linkage 122a, the second support linkage 122b, the fifth support linkage 122e and the sixth support linkage 122f support the first part 130, and the third support linkage 122c, the fourth support linkage 122e, the seventh support linkage 122g and the eighth support linkage 122f support the second part 132.

In an embodiment, the midgate 22 can include multiple parts that pivot independently. For example, FIGS. 11 and 12 further show the configuration of the midgate 22 in the closed configuration as the first part 130 and the second part 132 independently pivot into the stowed configuration. In an embodiment, the midgate 22 can include corresponding parts that partially open the open space 26 between the passenger cabin 12 and the cargo area 20 which exposes the passenger cabin 12 to the cargo area 20. This configuration would allow a passenger to sit on one of the first part 130 and the second part 132, while the other of the first part 130 and the second part 132 is lowered along with a portion of the midgate 22 to form an open space between the passenger cabin 12 and the cargo area 20. This configuration is advantageous, for example, so that items larger than the cargo area 20 can protrude into the passenger cabin 12 while a passenger sits in the upright portion of the vehicle seat 100.

In the illustrated embodiment, the vehicle seat 100 includes at least one headrest 134 pivotally connected to the seat backrest 104. The headrests 134 are configured to pivot with respect to the seat backrest 104 to reduce the radial extension of the seat backrest 104 when the seat backrest 104 pivots between the upright configuration and the stowed configuration. As seen for example in FIGS. 3 to 6, the headrest 134 can be positioned and dimensioned such that pivoting the headrest 134 forward enables the vehicle seat 100 to move from the upright configuration to the stowed configuration, and vice versa, without contacting any portion of another vehicle seat 200 positioned forward of the vehicle seat 100 in the passenger cabin 12. This allows the vehicle seats 100, 200 to be placed closer to each other than would otherwise be possible without the pivoting headrest 134. In the illustrated embodiment, the headrests 134 pivot approximately 90 degrees. This also allows the forward vehicle seat 200 to recline when the vehicle seat 100 is in the stowed configuration.

In the illustrated embodiment, the vehicle floor 18 includes a rear surface 18a to which the vehicle seat 100 is attached, and a forward surface 18b located forward of the rear surface 18a. As seen in FIGS. 5 and 6, the forward surface 18b is lower than the rear surface 18a. The forward surface 18b thus creates a cavity which partially receives the distal end of the headrest 134 when the vehicle seat 100 is in the stowed configuration. The cavity 18b allows for longer relative extension of the headrest 134 when the vehicle seat 100 is in the upright configuration.

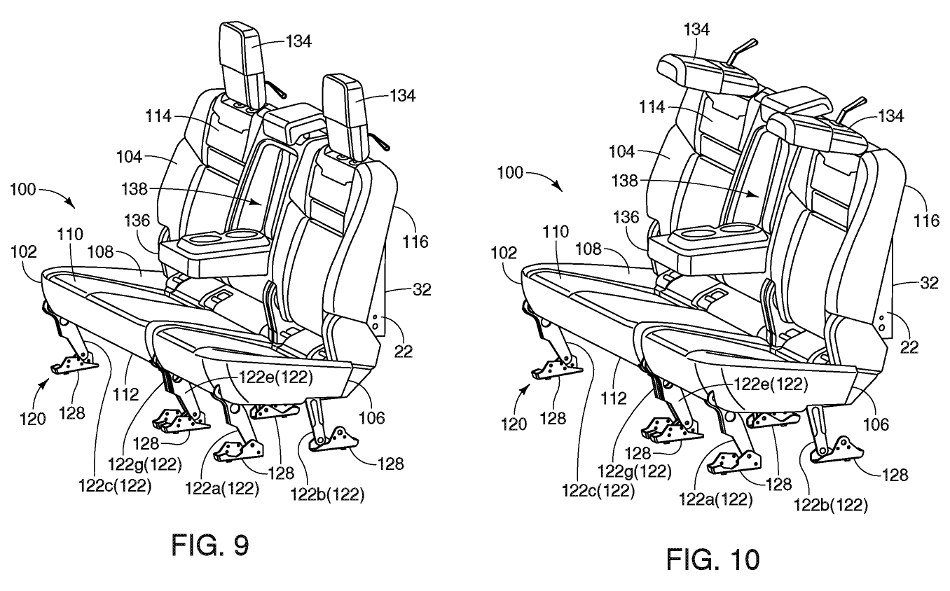

In the illustrated embodiment, the vehicle seat 100 includes at least one movable armrest 136. The movable armrest 136 pivots into and out of a corresponding cavity 138 in the seat backrest 104. FIG. 7 illustrates the armrest 136 stowed in the cavity 138, while FIGS. 9 and 10 illustrate the armrest 136 in a deployed configuration outside of the cavity 138. In an embodiment, the motion of moving the vehicle seat 100 from the upright configuration to the stowed configuration pushes the movable armrest 136 into the cavity 138. The armrest 136 can thus be either stowed or deployed when the vehicle seat 100 begins moving from the upright configuration to the stowed configuration.

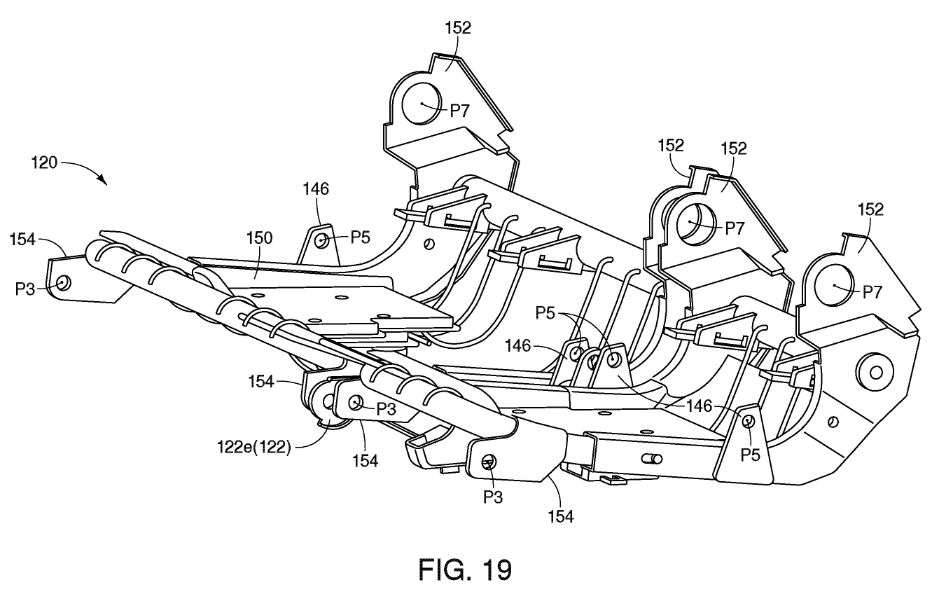

In the illustrated embodiment, the vehicle seat 100 includes at least one seat linkage 140 having a first end 142 and a second end 144. The first end 142 of the seat linkage 140 is pivotally attached to the seat bottom 102 at a pivot point P5. More specifically, and as further seen in FIGS. 22 and 23, the first end 142 is pivotally attached to a bracket 146 attached to the frame 150 of the seat bottom 102. The second end 144 of the seat linkage 140 is pivotally attached to the seat backrest 104 at a pivot point P6. More specifically, the second end 144 is pivotally attached to one or more bracket 148 attached to the seat backrest 104. The bracket 148 has a first end 158 and a second end 160, with the first end 158 pivotally attached to the seat linkage 140 at the pivot point P6, and the second end 160 pivotally attached to the seat bottom 102 at the pivot point P7. The seat linkages 140 cause the seat bottom 102 and the seat backrest 104 to simultaneously pivot when the vehicle seat 100 moves from the upright configuration to the stowed configuration or from the stowed configuration to the upright configuration. As seen in FIGS. 18 and 19, the vehicle seat 100 includes multiple brackets 146 for multiple seat linkages 140. The brackets 146 are located on the first lateral side 106, the second lateral side 108 and at an intermediate location of the seat bottom 104 and protrude upwardly from the frame 150.

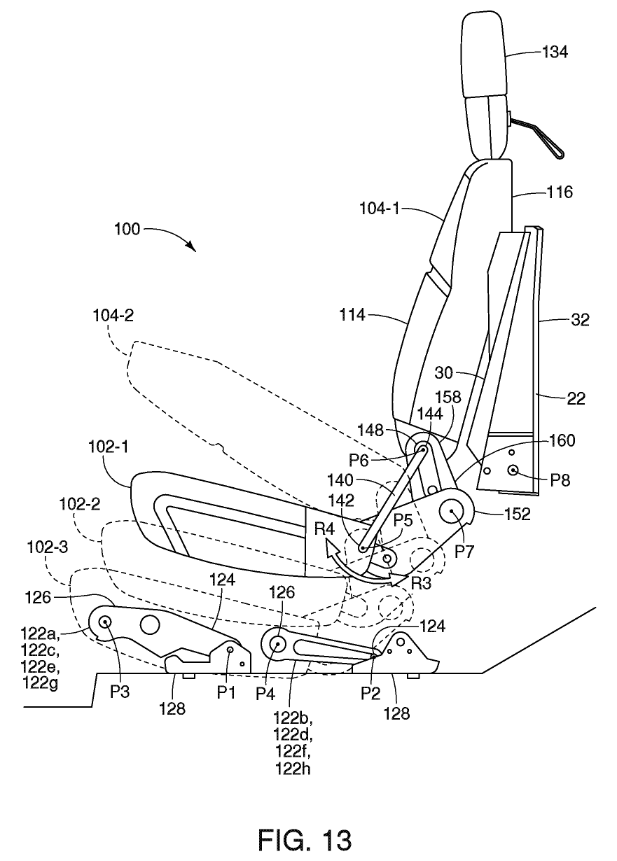

FIG. 13 illustrates how the parts of the vehicle seat 100 pivot between the upright configuration and the stowed configuration. More specifically, FIG. 13 shows the seat backrest 104 having a first or upright position 104-1 and a second or intermediate position 104-2. The third or stowed position of the seat backrest 104 is omitted from FIG. 13 for simplicity but is shown in FIGS. 14 to 17. FIG. 13 also shows the seat bottom 102 having a first or upright position 102-1, a second or intermediate position 102-2 and a third or stowed position 102-3. The third or stowed position 102-3 of the seat bottom 102 is also shown in FIGS. 14 to 17.

The vehicle seat 100 can be configured to automatically move between the upright configuration and the stowed configuration using a motor. The vehicle seat 100 can also be configured to be moved manually by a passenger. If a motor is included, the vehicle seat 100 is configured to cause the full movement of the seat bottom 102 and the seat backrest 104 by applying the motor force to only one of the seat bottom 102, the seat backrest 104 or the pivot structure 120. If manual movement is used, a passenger need only unlock the vehicle seat 100 (e.g., via a lever) and push or pull one of the seat bottom 102 or the seat backrest 104 in a desired direction to cause the full movement of the seat bottom 102 and the seat backrest 104 between the configurations shown.

The plurality of support linkages 122 move in the shape of a quadrilateral, parallelogram or rhomboid as they collapse the seat bottom 102 from the first position 102-1 to the third position 102-3. From the perspective of FIG. 13, the first support linkage 122a, the third support linkage 122c, the fifth support linkage 122e and the seventh support linkage 122g rotate at their respective first ends 124 around the pivot point P1 and at their second ends around the pivot point P3. The second support linkage 122b, the fourth support linkages 122d, the sixth support linkage 122f and the eighth support linkage 122h rotate at their respective first ends 124 around the pivot point P2 and at their second ends around the pivot point P4. The distance between the pivot point P1 and the pivot point P2 remains constant as the vehicle seat 100 moves between the upright configuration and the stowed configuration, and the distance between the pivot point P3 and the pivot point P4 remains constant as the vehicle seat 100 moves between the upright configuration and the stowed configuration. In an embodiment, the line between the pivot points P3 and P4 remains parallel with the line between the pivot points P1 and P2 as the vehicle seat 100 moves between the upright configuration and the stowed configuration. The locations of the pivot points P1 and P2 also remain the same as the vehicle seat 100 moves between the upright configuration and the stowed configuration.

As seen in FIG. 13, when the vehicle seat 100 is in the upright configuration, the seat bottom 102 is in the first position 102-1 and the seat backrest 104 is in the first position 104-1. As the seat linkages 140 pivot at the first ends 142 and the second ends 144, the seat bottom 102 moves to the second position 102-2 and the seat backrest 104 moves to the second position 104-2. More specifically, each seat linkage 140 pivots at the first end 142 around the pivot point P5 in the rotational direction R3 shown in FIG. 13, and each seat linkage 140 also pivots at the second end 144 around the pivot point P6 in the same rotational direction R3. When a motor or passenger applies force to the support linkages 122 or the seat bottom 102 to move the seat bottom 102 to the second position 102-2, the motion of the seat linkage 140 also pulls the seat backrest 104 into the second position 104-2. Likewise, when a motor or passenger applies force to move the seat backrest 104 into second position 104-2, the motion of the seat linkage 140 also pushes the seat bottom 102 into the second position 104-2.

As the seat bottom 102 moves to the third position 102-3 and the seat backrest 104 moves to the third position (e.g., as seen in FIG. 14), the seat linkage 140 continues to pivot at the first end 142 and the second end 144 in the same rotational direction R3 around the pivot points P5, P6. As the force of the motor or passenger to the support linkages 122 or the seat bottom 102 causes the seat bottom 102 to continue to move to the third position 102-3, the motion of the seat linkage 140 also pulls the seat backrest 104 into the third position (e.g., as seen in FIGS. 14 to 17). Likewise, as the motor or passenger applies force to move the seat backrest 104 into the third position, the motion of the seat linkage 140 also pushes the seat bottom 102 into the third position 102-3. As seen in FIG. 14, the seat backrest 104 moves into the space previously occupied by the seat bottom 102 when the vehicle seat 100 moves from the upright configuration to the stowed configuration.

The same principles apply as the vehicle seat 100 moves back from the stowed configuration to the upright configuration. A motor or passenger force applied to the support linkages 122 or the seat bottom 102 transfers to also move the seat backrest 104 back to the first position 104-1 via the seat linkage 140, or a force applied to the seat backrest 104 transfers to move the seat bottom 102 back to the first position 102-1 via the seat linkage 140. Multiple seat linkages 140 can be used on one or more of the first lateral side 106, the second lateral side 108, or any intermediate portion of the vehicle seat 100. As seen in FIGS. 18 and 19, the frame 150 of the seat bottom 102 includes brackets 146 for seat linkages 140 at each of the first lateral side 106, the second lateral side 104 and at an intermediate portion.

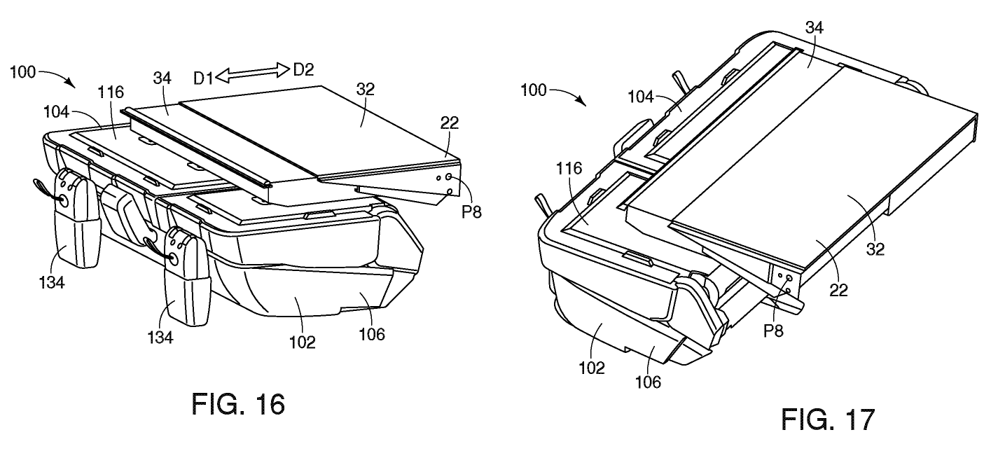

FIGS. 16 and 17 show the vehicle seat 100 in the stowed configuration, with the midgate 22 in the open configuration. The midgate 22 pivots around the pivot point P8 to be placed in the open configuration. In this configuration, the protruding surface 34 of the midgate 22 rests on the rear surface 116 of the seat backrest 104. The protruding surface 34 prevents the angled front surface 30 of the midgate 22 from contacting the rear surface 116 of the seat backrest 104. In an embodiment, the protruding surface 34 includes a deformable surface such as a cushioned surface configured to slightly deform under the weight of the midgate 22 when the midgate 22 is in the open configuration.

In an embodiment, the protruding surface 34 can translate with respect to the rest of the midgate 22. For example, as seen in FIG. 16, the protruding surface 34 can be configured to translate across the rear surface 116 of the seat backrest 104 in the directions D1 and D2 to engage a larger surface area of the rear surface 116 and/or to support the midgate 22 at different positions.

The positioning of the protruding surface 34 also causes the rear surface 32 of the midgate 22 to be generally horizontal when the midgate 22 is in the open configuration. As seen in FIG. 6, the generally horizontal rear surface 32 is approximately level with the cargo area floor 24 in the vertical direction. This level horizontal surface is enabled by the seat bottom 102 collapsing towards the vehicle floor 18 and the seat backrest 104 folding towards the seat bottom 102 as described above.

FIG. 18 shows the frame 150 of the seat bottom 102 pivotally attached to the support linkages 122 at the second ends 126, while FIG. 19 shows the frame 150 without the support linkages 122. In addition to the structure described above, the frame 150 includes or has attached thereto one or more first brackets 152 and one or more second brackets 154. The seat backrest 104 is pivotally attached to the frame 150 of the seat bottom 102 via the first brackets 152 and is configured to rotate around the pivot point P7. The second brackets 154 are located on the lower side of the seat bottom 102. The second ends 126 of the support linkages 122 are pivotally attached to the second brackets 154.

In an embodiment, the structure and mechanisms described herein can be used to configure a platform that does not open or close to the outside environment. That is, the midgate 22 can be replaced by a platform located rear of the vehicle seat 100 or modified so as not to open to the outside environment. In an embodiment, the platform includes the midgate 22 configured to open and close the open space 26 to the cargo area 20. Thus, a platform as described herein can be configured to move between a lowered configuration (e.g., the open configuration of the midgate 22 described herein) in which the platform is located above at least one of the seat bottom 102 and the seat backrest 104 and a raised configuration (e.g., the closed configuration of the midgate 22 described herein) in which the platform is not located above the seat bottom 102 or the seat backrest 104. The pivot structure 120 can also be used as described herein to attach the seat bottom 102 to a floor 18 of the passenger cabin 12, with the pivot structure 102 configured to pivot the seat bottom 102 towards and away the floor 18 to enable the platform to move between the raised configuration and the lowered configuration.

The illustrated vehicle 10 is a pickup truck, but those of ordinary skill in the art will recognize from this disclosure that the mechanisms described herein can also be applied to other types of vehicles 10. For example, a vehicle seat 100 that moves as disclosed herein can be advantageous in a car, an SUV, a van or another vehicle 10 because it can be stowed as desired to create additional room in the passenger cabin 12. A vehicle seat 100 that moves as disclosed herein can also be advantageous as a rear seat in another vehicle 10 to create an open space from the passenger cabin 12 to a cargo area 20 such as the trunk of the vehicle 10.

The embodiments described herein provide a vehicle seat 100 configured to collapse towards the floor 18 of the passenger cabin 12 and support a movable midgate 22 or other platform. These systems and methods are advantageous, for example, because they maximize space and versatility of a vehicle cabin 12 and a cargo area 20. It should be understood that various changes and modifications to the systems and methods described herein will be apparent to those skilled in the art and can be made without diminishing the intended advantages.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle seat assembly, the vehicle seat assembly comprising:
a seat bottom;
a seat backrest pivotally attached to the seat bottom;
a plurality of support linkages configured to support the seat bottom above a vehicle floor, the plurality of support linkages each having a first end and a second end, the first end configured to pivotally attach to the vehicle floor and the second end pivotally attached to the seat bottom,
the plurality of support linkages configured to simultaneously pivot at both the first end and the second end to move the seat bottom towards the vehicle floor when the seat bottom moves from an upright configuration to a stowed configuration and to move the seat bottom away from the vehicle floor when the seat bottom moves from the stowed configuration to the upright configuration.

2. The vehicle seat assembly of claim 1, wherein
the plurality of support linkages include at least a first support linkage located on a first side of the seat bottom and a second support linkage located on an opposite second side of the seat bottom.

3. The vehicle seat assembly of claim 1, comprising
at least one seat linkage having a first end and a second end,
the first end of the seat linkage being pivotally attached to the seat bottom,
the second end of the seat linkage being pivotally attached to the seat backrest, and
the seat linkage causing the seat bottom and the seat backrest to simultaneously pivot when the seat bottom moves from the upright configuration to the stowed configuration or from the stowed configuration to the upright configuration.

4. The vehicle seat assembly of claim 1, wherein
the first ends of the plurality of support linkages are pivotally attached to the floor via brackets fixed to the floor.

5. The vehicle seat assembly of claim 1, wherein
the seat backrest includes a first part and a second part that pivot towards the seat bottom independently of each other.

6. The vehicle seat assembly of claim 1, wherein
the vehicle seat includes at least one headrest pivotally connected to the seat backrest, the at least one headrest configured to pivot forward with respect to the seat backrest to reduce a radial extension when the seat backrest pivots towards the seat bottom and the vehicle floor.

7. A vehicle including the vehicle seat assembly of claim 1, the vehicle further comprising
a passenger cabin having a front side, a rear side and the vehicle floor,
a cargo area located on the rear side of the passenger cabin, and
a midgate located between the passenger cabin and the cargo area, the midgate configured to move between (i) an open configuration in which the passenger cabin is open to the cargo area, the seat bottom is in the stowed configuration, and the midgate is located above the seat bottom and the seat backrest, and (ii) a closed configuration in which the passenger cabin is closed off from the cargo area by the midgate and the seat bottom is in the upright configuration.

8. A vehicle comprising:
a passenger cabin having a front side, a rear side and a floor;
a cargo area located on the rear side of the passenger cabin;
a vehicle seat located inside the passenger cabin, the vehicle seat including a seat bottom and a seat backrest and being configured to move between an upright configuration and a stowed configuration;
a pivot structure attaching the seat bottom to the floor of the passenger cabin, the pivot structure configured to (i) pivot the seat bottom towards the floor when the vehicle seat moves from the upright configuration to the stowed configuration and (ii) pivot the seat bottom away from the floor when the vehicle seat moves from the stowed configuration to the upright configuration; and
a midgate located between the passenger cabin and the cargo area, the midgate configured to move between (i) an open configuration in which the passenger cabin is open to the cargo area, the vehicle seat is in the stowed configuration, and the midgate is located above the seat bottom and the seat backrest and (ii) a closed configuration in which the passenger cabin is closed off from the cargo area by the midgate and the vehicle seat is in the upright configuration.

9. The vehicle of claim 8, wherein
the pivot structure includes a plurality of support linkages attaching the seat bottom to the floor of the passenger cabin, the plurality of support linkages having a first end pivotally attached to the floor and a second end pivotally attached to the seat bottom.

10. The vehicle of claim 9, wherein
the pivot structure includes a plurality of brackets fixed to the floor, and
the first ends of the plurality of support linkages are pivotally attached to the brackets.

11. The vehicle of claim 8, wherein
the vehicle seat includes at least one seat linkage having a first end and a second end,
the first end of the seat linkage is pivotally attached to the seat bottom,
the second end of the seat linkage is pivotally attached to the seat backrest, and
the seat linkage causes the seat bottom and the seat backrest to simultaneously pivot when the vehicle seat moves from the upright configuration to the stowed configuration or from the stowed configuration to the upright configuration.

12. The vehicle of claim 8, wherein
the midgate has a generally horizontal upper surface when in the open configuration.

13. The vehicle of claim 8, wherein
the seat backrest includes a first part and a second part that pivot towards the seat bottom independently of each other.

14. The vehicle of claim 8, wherein
the vehicle seat includes at least one headrest pivotally connected to the seat backrest, the at least one headrest configured to pivot forward with respect to the seat backrest to reduce a radial extension of the vehicle seat when the vehicle seat moves between the upright configuration and the stowed configuration.

15. A vehicle comprising:
a passenger cabin having a front side and a rear side;
a cargo area located on the rear side of the passenger cabin;
a vehicle seat located inside the passenger cabin, the vehicle seat including a seat bottom and a seat backrest and being configured to move between an upright configuration and a stowed configuration; and
a midgate located between the passenger cabin and the cargo area, the midgate configured to move between (i) an open configuration in which the passenger cabin is open to the cargo area, the vehicle seat is in the stowed configuration, and an upper surface of the midgate is generally horizontal and located above the seat bottom and the seat backrest and (ii) a closed configuration in which the passenger cabin is closed off from the cargo area by the midgate and the vehicle seat is in the upright configuration.

16. The vehicle of claim 15, comprising
a pivot structure attaching the seat bottom to a floor of the passenger cabin, the pivot structure configured to (i) pivot the seat bottom towards the floor when the vehicle seat moves from the upright configuration to the stowed configuration and (ii) pivot the seat bottom away from the floor when the vehicle seat moves from the stowed configuration to the upright configuration.

17. The vehicle of claim 15, comprising
a plurality of support linkages each having a first end and a second end, the plurality of support linkages pivotally attached to the floor of the passenger cabin at the first end and pivotally attached to the seat bottom at the second end, the plurality of support linkages moving the seat bottom towards the floor when the vehicle seat moves from the upright configuration to the stowed configuration and away from the floor when the vehicle seat moves from the stowed configuration to the upright configuration.

18. The vehicle of claim 17, wherein
the plurality of support linkages are pivotally attached to the floor via brackets fixed to the floor.

19. The vehicle of claim 17, wherein
the plurality of support linkages support the seat bottom above the floor when the vehicle seat is in the upright configuration.

20. The vehicle of claim 17, wherein
the plurality of support linkages simultaneously pivot at the first end and at the second end when the vehicle seat moves between the upright configuration and the stowed configuration.
